(19) United States
(12) Patent Application Publication
(10) Pub. No.: US 2014/0158457 A1
(43) Pub. Date: Jun. 12, 2014

(54) COULOMB FRICTIONAL DAMPING COATED PRODUCT

(71) Applicant: GM GLOBAL TECHNOLOGY OPERATIONS LLC, Detroit, MI (US)

(72) Inventor: Michael D. Hanna, West Bloomfield, MI (US)

(73) Assignee: GM Global Technology Operations LLC, Detroit, MI (US)

(21) Appl. No.: 13/712,338

(22) Filed: Dec. 12, 2012

(51) Int. Cl. G10K 11/168

(52) U.S. Cl. CPC G10K 11/168
USPC 181/207; 427/359; 427/180; 427/508; 427/512; 427/553

(57) ABSTRACT

One variation may include a method of making frictional surfaces for products having coulomb friction damping are provided. The method may include coating a metallic member with a coating including friction material. The metallic member may be pressure rolled to achieve a desired coating thickness and or the metallic member may be micro-waved to cure the coating.

### TECHNICAL FIELD

The field to which the disclosure generally relates includes products and components thereof including means for coulomb frictional damping and methods of making and using the same.

### BACKGROUND

Product parts may produce undesirable noise when vibrated, or may vibrate at an undesirable amplitude for a prolonged period when struck or set in motion. The use of a coulomb friction damping product may reduce the amount of undesired noise. A greater understanding of coulomb friction damping products may be gained from a review of US Patent Application Publications 200710062664 published Mar. 22, 2007 and 2009/0107787 published Apr. 30, 2009.

### SUMMARY OF SOME OF THE VARIATIONS OF THE INVENTION

One variation may include a method of making an insert having coated friction surfaces for coulomb frictional damping.

Other variation of the invention will become apparent from the detailed description provided hereinafter. It should be understood that the detailed description and specific examples, while disclosing variations of the invention, are intended for purposes of illustration only and are not intended to limit the scope of the invention.

### BRIEF DESCRIPTION OF THE DRAWINGS

Illustrative variations of the invention will become more fully understood from the detailed description and the accompanying drawings, wherein:

FIG. 1 is a sectional view with portions broken away of embodiment number of variations of a coulomb friction damping product that includes an insert.

FIG. 2 is a sectional view with portions broken away of a number of variations t of a coulomb friction damping product including an insert having a layer thereon to provide a frictional surface or damping.

FIG. 3 is a sectional view with portions broken away of a number of variations t of a coulomb friction damping product.

FIG. 4 is an enlarged sectional view with portions broken away of a number of variations of a coulomb damping friction product.

FIG. 5 illustrates a number of variations of a coulomb friction damping product.

FIG. 6 is a sectional view with portions broken away of a number of variations a coulomb friction damping product.

FIG. 7 is a sectional view with portions broken away of a number of variations of a coulomb friction damping product.

FIG. 8 is a plan view with portions broken away illustrating a number of variations of a coulomb friction damping product.

FIG. 9 is a sectional view taken along line 9-9 of FIG. 8 illustrating a number of variations of a coulomb friction damping product.

FIG. 10 is a sectional view with portions broken away illustrating a number of variations of a coulomb friction damping product.

FIG. 11 is a sectional view, with portions broken away illustrating a number of variations of a coulomb friction damping product.

FIG. 12 is a schematic view of a number of variations of a method of making a friction surface for a coulomb friction damping product.

FIG. 13 is a schematic view of a number of variations of a method of making a friction surface for a coulomb friction damping product.

### DETAILED DESCRIPTION OF SOME VARIATIONS

The following description of the variations is merely illustrative in nature and is in no way intended to limit the invention, its application, or uses.

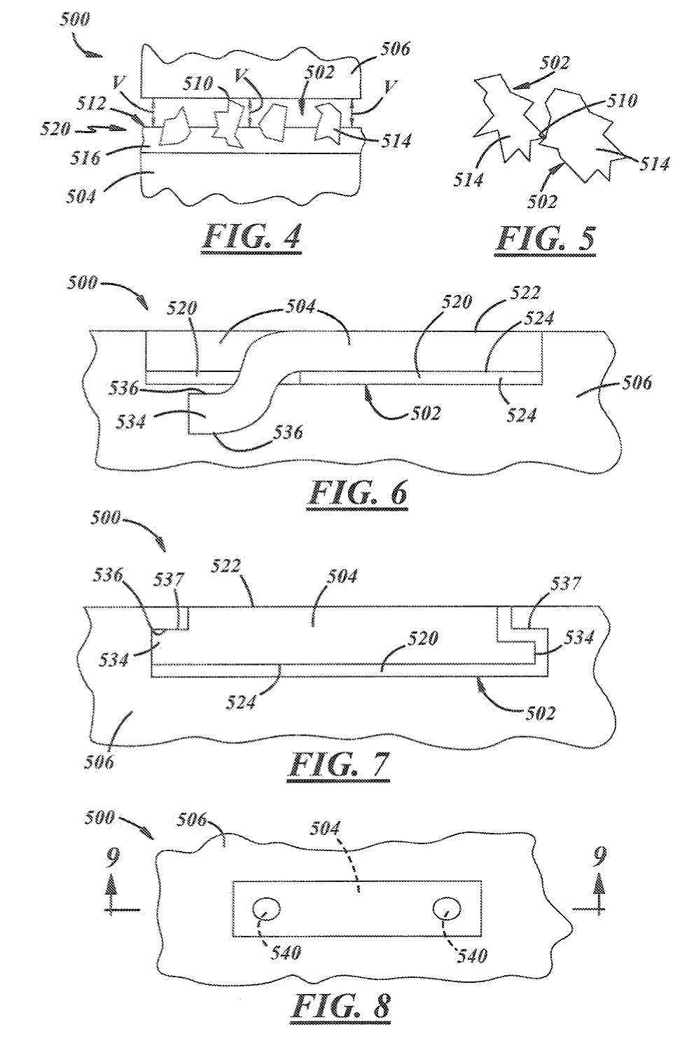

FIGS. 1-13 illustrate a number of variations of the invention. The variations may include a product or part 500 having a frictional damping means. The frictional damping means may be used in a variety of applications including, but not limited to, applications where it is desirable to reduce noise associated with a vibrating part or reduce the vibration amplitude and/or duration of a part that is struck, dynamically loaded, excited, or set in motion. In one variation, the frictional damping means may include an interface boundary conducive to frictionally damping a vibrating part. In one variation, the damping means may include frictional surfaces 502 constructed and arranged to move relative to each other and in frictional contact, so that vibration of the part is dissipated by frictional damping due to the frictional movement of the surfaces 502 against each other.

Ina a number of variations the frictional damping may be achieved by the movement of the frictional surfaces 502 against each other. The movement of frictional surfaces 502 against each other may include the movement of: a surface of the body 506 of the part against the layer 520; a surface of the insert 504 against the layer 520.

In variations wherein the frictional surface 502 is provided as a layer 520 over one of the same, the frictional surface 502 may have a minimal area over which frictional contact may occur that may extend in a first direction a minimum distance of 0.1 mm and/or may extend in a second (generally traverse) direction a minimum distance of 0.1 mm. In one variation, the insert 504 may be an annular body and the area of frictional contact on a frictional surface 502 may extend in an annular direction a distance ranging from about 20 mm to about 1000 mm and in a transverse direction ranging from about 10 mm to about 75 mm. The frictional surface 502 may be provided in a variety of variations, for example, as illustrated in FIGS. 1-11.

One variation of the invention may include a layer 520 including the particles 514, flakes, and or fibers. The particles 514, flakes, or fibers may have an irregular shape (e.g., not smooth) to enhance frictional damping, (one variation being illustrated in FIG. 5). The particles 514, flakes, or fibers of the layer 520 may be bonded to each other or to a surface of the body 506 of the part or a surface of the insert 504 due to the inherent bonding properties of the particles 514, flakes, or fibers. For example, the bonding properties of the particles 514, flakes, or fibers may be such that the particles 514, flakes, or fibers may bind to each other or to the surfaces of the body 506 or the insert 504 under compression to form the coating 520. In many variations of the invention, the particles 514, flakes, or the fibers may be mixed with a binder to bind the particles together and to attach the particles to at least one of a surface of the body 506 or a surface of the insert 504.

In variations wherein at least a portion of the part 500 is manufactured such that the insert 504 and/or the particles 514, flakes, or fibers are exposed to the temperature of a molten material such as in casting, the insert 504 and/or particles 514, flakes, or fibers may be made from materials capable of resisting flow or resisting significant erosion during the manufacturing. For example, the insert 504 and/or the particles 514, flakes, or fibers may include refractory materials capable of resisting flow or that do not significantly erode at temperatures above 600° C., above 1300° C., or above 1500° C. When molten material, such as metal, is cast around the insert 504 and/or the particles 514, flakes, or fibers, the insert 504 or the particles 514, flakes, or fibers should not be wet by the molten material so that the molten material does not bond to the insert 504 or layer 520 at locations wherein a frictional surface 502 for providing frictional damping is desired.

Illustrative examples of suitable particles 514 or fibers include, but are not limited to, particles or fibers including silica, alumina, graphite with clay, silicon carbide, silicon nitride, cordierite (magnesium-iron-aluminum silicate), mullite (aluminum silicate), zirconia (zircon urn oxide), phyllosilicates, or other high-temperature-resistant particles. In one variation of the invention the particles 514, flakes, or fibers may have a length along the longest dimension thereof ranging from about 1 μm-500 μm or 10 μm-250 μm.

In variations wherein the part 500 is made using a process wherein the insert 504 and/or the particles 514, flakes, or fibers are not subjected to relatively high temperatures associated with molten materials, the insert 504 and/or particles 514, flakes, or fibers may be made from a variety of other materials including, but not limited to, non-refractory polymeric materials, ceramics, composites, wood or other materials suitable for frictional damping. For example, such non-refractory materials may also be used (in additional to or as a substitute for refractory materials) when two portions of the body 506 of the part 500 are held together mechanically by a locking mechanism, or by fasteners, or by adhesives, or by welding 518 (one variation being illustrated in FIG. 3).

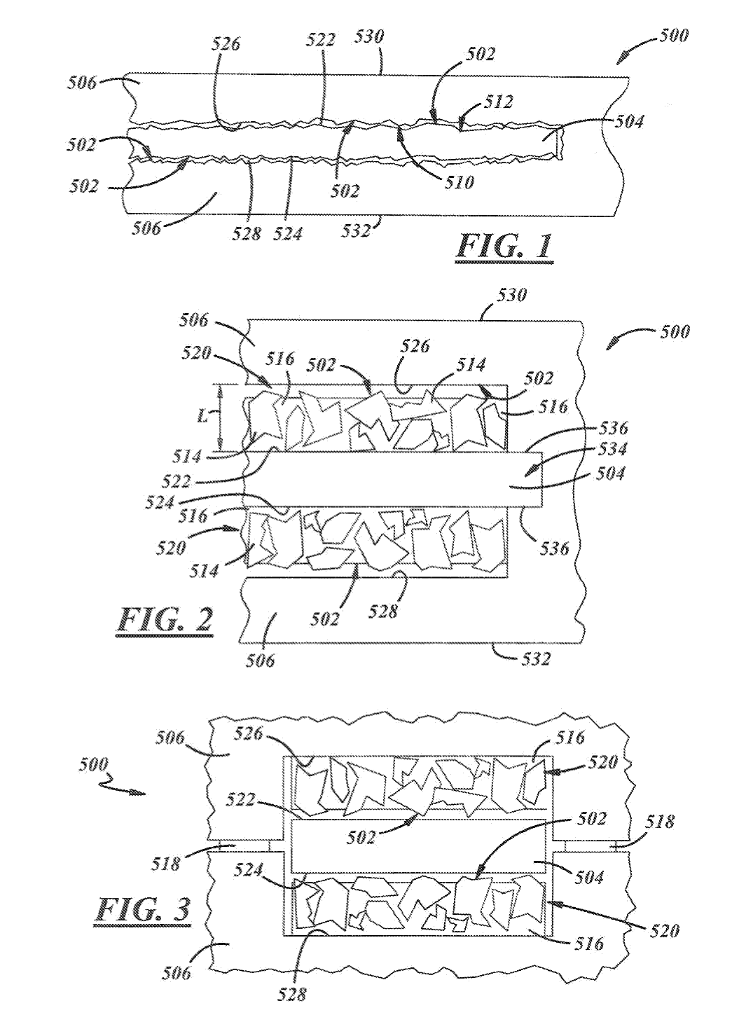

The layer 520 may be a coating over the body 506 of the part or the insert 504. The coating may include a plurality of particles 514, flakes, or fibers which may be bonded to each other and/or to the surface of the body 506 of the part or the insert 504 by an inorganic or organic binder 516 (some variation being illustrated in FIGS. 2-4) or other bonding materials. Illustrative examples of suitable binders include, but are not limited to, epoxy resins, phosphoric acid binding agents, calcium aluminates, sodium silicates, wood flour, or clays. In another variation of the invention the particles 514, flakes, or fibers may be held together and/or adhered to the body 506 or the insert 504 by an inorganic binder. In one variation, the coating may be deposited on the insert 504 or body 506 as a liquid dispersed mixture of alumina-silicate-based, organically bonded refractory mix.

In another variation, the coating may include at least one of alumina or silica particles, mixed with a lignosulfonate binder, cristobalite (SiO₂), quartz, or calcium lignosulfonate. The calcium lignosulfonate may serve as a binder. In one embodiment, the coating may include ironKote. In one variation, a liquid coating may be deposited on a portion of the insert and may include any high temperature ceramic coating, such as but not limited to, Ladle Kote 310B. In another variation, the coating may include at least one of clay, Al₂O₃, SiO₂, a graphite and clay mixture, silicon carbide, silicon nitride, cordierite (magnesium-iron-aluminum silicate), mullite (aluminum silicate), zirconia (zirconium oxide), or phyllosilicates. In one variation, the coating may comprise a fiber such as ceramic or mineral fibers.

When the layer 520 including particles 514 or fibers is provided over the insert 504 or the body 506 of the part the thickness L (FIG. 2) of the layer 520, particles 514 and/or fibers may vary. In some variations, the thickness L of the layer 520, particles 514, flakes, and/or fibers may range from about 1 μm-500 μm, 10 μm-400 μm, 30 μm-300 μm, 30 μm-40 μm, 40 μm-100 μm, 100 μm-120 μm, 120 μm-200 μm, 200 μm-300 μm, 200 μm-250 μm, or variations of these ranges.

In yet another variation of the invention, the particles 514 or fibers may be temporarily held together and/or to the surface of the insert 504 by a fully or partially sacrificial coating. The sacrificial coating may be consumed by molten metal or burnt off when metal is cast around or over the insert 504. The particles 514, flakes, or fibers are left behind trapped between the body 506 of the cast part and the insert 504 to provide a layer 520 consisting of the particles 514, flakes, or fibers or consisting essentially of the particles 514, flakes, or fibers.

The layer 520 may be provided over the entire insert 504 or only over a portion thereof. In one variation of the invention the insert 504 may include a tab 534 (FIG. 2). For example, the insert 504 may include an annular body portion and a tab 534 extending radially inward or outward therefrom. In one variation of the invention at least one wettable surface 536 of the tab 534 does not include a layer 520 including particles 514, flakes, or fibers, or a wettable material such as graphite is provided over the tab 534, so that the cast metal is bonded to the wettable surface 536 to attach the insert 504 to the body 506 of the part 500 but still allow for frictional damping over the remaining insert surface which is not bonded to the casting.

In one variation of the invention at least a portion of the insert 504 is treated or the properties of the insert 504 are such that molten metal will not wet or bond to that portion of the insert 504 upon solidification of the molten metal. According to one variation of the invention at least one of the body 506 of the part or the insert 504 includes a metal, for example, but not limited to, aluminum, titanium, steel, stainless steel, cast iron, any of a variety of other alloys, or metal matrix composite including abrasive particles. In one variation of the invention the insert 504 may include a material such as a metal having a higher melting point than the melting point of the molten material being cast around a portion thereof.

In one variation the insert 504 may have a minimum average thickness of 0.2 mm and/or a minimum width of 0.1 mm and/or a minimum length of 0.1 mm. In another variation the insert 504 may have a minimum average thickness of 0.2 mm and/or a minimum width of 2 mm and/or a minimum length of 5 mm. In other variations the insert 504 may have a thickness ranging from about 0.1-20 mm, 0.1-6.0 mm, or 1.0-2.5 mm, or ranges therebetween.

In some variations of the invention improvements in the frictional damping may be achieved by adjusting the thickness (L, as shown in FIG. 2) of the layer 520.

In one variation the insert 504 is not pre-loaded or under pre-tension or held in place by tension. In one variation the insert 504 is not a spring. Another variation of the invention includes a process of casting a material comprising a metal around an insert 504 with the proviso that the frictional surface 502 portion of the insert used to provide frictional damping is not captured and enclosed by a sand core that is placed in the casting mold. In some variations the insert 504 or the layer 520 includes at least one frictional surface 502 or two opposite friction surfaces 502 that are completely enclosed by the body 506 of the part. In another variation the layer 520 including the particles 514, flakes, or fibers that may be completely enclosed by the body 506 of the part or completely enclosed by the body 506 and the insert 504, and wherein at least one of the body 506 or the insert 504 comprises a metal or consists essentially of a metal. In one variation of the invention the layer 520 and/or insert 504 does not include or is not carbon paper or cloth.

Referring again to FIGS. 1-3, in many variations of the invention the insert 504 may include a first face 522 and an opposite second face 524 and the body 506 of the part may include a first inner face 526 adjacent the first face 522 of the insert 504 constructed to be complementary thereto, for example nominally parallel thereto. The body 506 of the part may include a second inner face 528 adjacent to the second face 524 of the insert 504 constructed to be complementary thereto, for example parallel thereto. The body 506 may include a first outer face 530 overlying the first face 522 of the insert 504 constructed to be complementary thereto, for example parallel thereto. The body 506 may include a first outer face 532 overlying the second face 524 of the insert 504 constructed to be complementary thereto, for example parallel thereto. However, in other variations of the invention the outer faces 530, 532 of the body 506 are not complementary to associated faces 522, 524 of the insert 504. In other variations the surfaces 526 and 528; 526 and 522; or 528 and 524 are mating surfaces but not parallel to each other.

Referring to FIGS. 6-7, in one variation of the invention the insert 504 may be an inlay wherein a first face 522 thereof is not enclosed by the body 506 of the part. The insert 504 may include a tang or tab 534 which may be bent downward (one variation being shown in FIG. 6). In one variation of the invention a wettable surface 536 may be provided that does not include a layer 520 including particles 514, flakes, or fibers, or a wettable material such as graphite is provided over the tab 534, so that the cast metal is bonded to the wettable surface 536 to attach the insert 504 to the body of the part but still allow for frictional damping on the non-bonded surfaces. A layer 520 including particles 514, flakes, or fibers may underlie the portion of the second face 524 of the insert 504 not used to make the bent tab 534.

In another variation the insert 504 includes a tab 534 that may be formed by machining a portion of the first face 522 of the insert 504 (FIG. 7). The tab 534 may include a wettable surface 536 having cast metal bonded thereto to attach the insert 504 to the body of the part but still allow for friction damping by way of the non-bonded surfaces. A layer 520 including particles 514, flakes, or fibers may underlie the entire second face 524 or a portion thereof. In other variations of the invention all surfaces including the tabs 534 may be non-wettable, for example by way of a coating 520 thereon, and features of the body portion 506 such as, but not limited to, a shoulder 537 may be used to hold the insert 504 in place.

Referring now to FIG. 8, one variation of the invention may include a part 500 having a body portion 506 and an insert 504 enclosed by the body part 506. The insert 504 may include through holes formed therein so that a stake or post 540 extends into or through the insert 504.

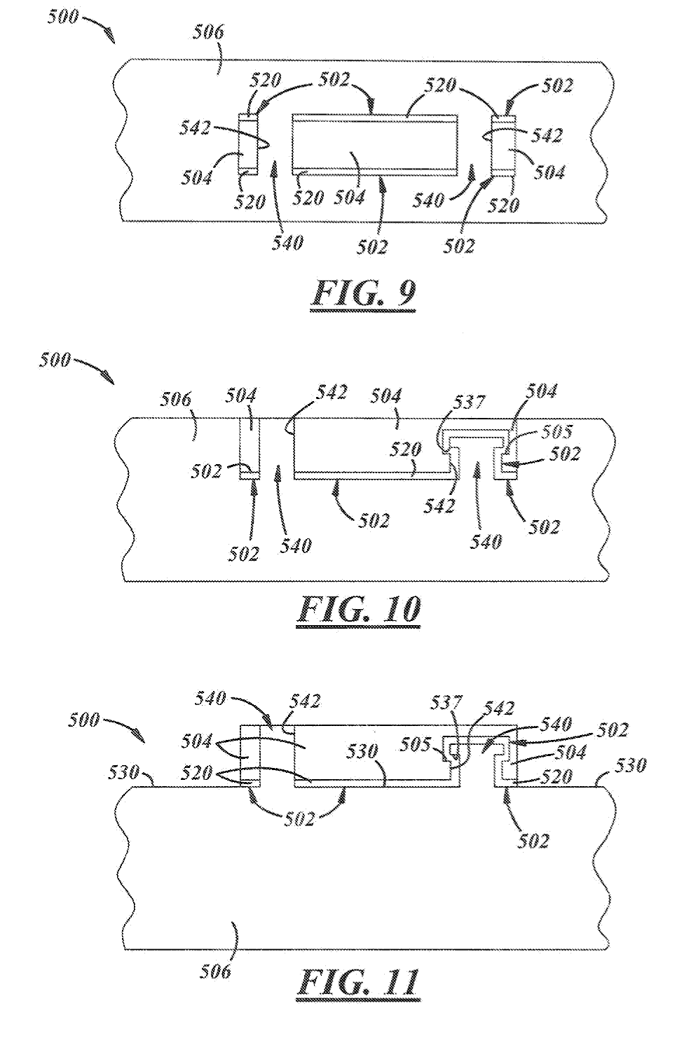

FIG. 9 is a sectional view of FIG. 8 taken along line 9-9. In one variation of the invention a layer 520 including a plurality of particles 514, flakes, or fibers (not shown) may be provided over at least a portion of the insert 504 to provide a frictional surface 502 and to prevent bonding thereto by cast metal. The insert 504 including the layer 520 may be placed in a casting mold and molten metal may be poured into the casting mold and solidified to form the post 540 extending through the insert 504. An inner surface 542 defining the through hole of the insert 504 may be free of the layer 520 or may include a wettable material thereon so that the post 540 is bonded to the insert 504. Alternatively, in another variation the post 540 may not be bonded the insert 504 at the inner surface 542. The insert 504 may include a feature such as, but not limited to, a shoulder 505 and/or the post 540 may include a feature such as, but not limited to, a shoulder 537 to hold the insert in place.

Referring now to FIG. 10, in another variation, the insert may be provided as an inlay in a casting including a body portion 506 and may include a post 540 extending into or through the insert 504. The insert 504 may be bonded to the post 540 to hold the insert in place and still allow for frictional damping. In one variation of the invention the insert 504 may include a recess defined by an inner surface 542 of the insert 504 and a post 540 may extend into the insert 504 but not extend through the insert 504. In one variation the post 540 may not be bonded to the insert 504 at the inner surface 542. The insert 504 may include a feature such as, but not limited to, a shoulder 505 and/or the post 540 may include a feature such as, but not limited to, a shoulder 537 to hold the insert in place.

Referring now to FIG. 11, in another variation of the invention, an insert 504 or substrate may be provided over an outer surface 530 of the body portion 506. A layer 520 may or may not be provided between the insert 504 and the outer surface 530. The insert 504 may be constructed and arranged with through holes formed therethrough or a recess therein so that cast metal may extend into or through the insert 504 to form a post 540 to hold the insert in position and still allow for frictional damping. The post 540 may or may not be bonded to the insert 504 as desired. The post 540 may extend through the insert 504 and join another portion of the body 506 if desired.

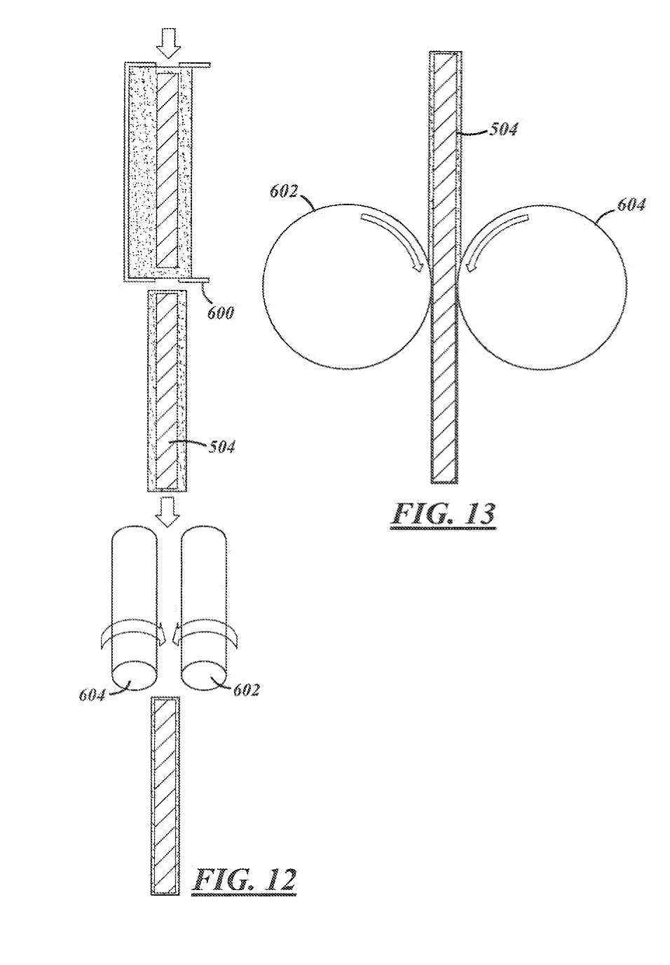

Referring now to FIGS. 12 and 13, one embodiment includes a method of manufacturing a product with a coulomb frictional damping surface which provides a frictional surface 502 that is for an metallic member insert 504, however the method may be used to provide a frictional surface 502 for a body 506.

In many variations insert 504 may be steel, stainless steel, aluminum or other metal. The insert 504 may be a continuous strip or parallel strips that intersect to form a mesh. Thickness, shape, and configuration may vary depending upon the application. In most applications a binder as previous as described may be mixed with friction materials as previously described to form a coating. The insert 504 may be coated with the coating. The coating process may be accomplished by spraying, dipping and or injecting insert 504 with a covering of a fluid, powder or paste of the coating. As shown, the insert 504 may be passed through a tank 600. The coating process may occur at room or at any other controlled temperature. If a paste is utilized, it should be of adequate this custody and particle size to allow penetration of the coating into the grid are solid strip of the insert 504.

The coated insert 504 may be passed through rollers 602 and 604. As shown the insert 504 may take a generally horizontal path. Referring to FIG. 13, in other variations the insert may take a vertical path. In still other embodiments (not shown), the rollers allow the insert to take an inclined path. The rollers 602 and 604 may be aligned on opposite sides of the insert 504. In other environments (not shown), the rollers 602 and 604 may be staggered. In still other variations, there may be multiple rollers 602 and 604. The positioning, forced placed upon (or pressure) of the roller 602, 604, or rotational speed (or derivatives thereof) of the rollers may be adjusted to control the coating thickness. The adjustment of the rollers rotational speed, pressure or position may be a function dependent upon properties of the insert, an environment of the insert and or the coating including but not limited to: weight of the insert; viscosity of the coating; temperature of the insert or coating; atmospheric humidity; desired thickness of the coating; a differential of a desired coating thickness and an actual coating thickness of a currently rolled insert and/or a previously rolled insert. Roller adjustment may be also a function of a sequence of coating for multiple coated inserts, or a relationship dependent upon a linear displacement or derivatives thereof of the insert 504 versus linear displacement or derivatives thereof of a surface of the roller. Roller adjustment may be manual or automatic.

The direction of rotation of the rollers 602, 604 may be the same as the linear path of the insert or may be counter thereto. The rollers 602, 604 may be custom configured to match a contour of the insert 504.

To cure the coating 520 on the insert 504 the insert 504 may be exposed to microwave energy. With microwave energy, the heat is generated in the center of the coating as compared with conventional heating method wherein the heat migrates to the center. Heating the center of the coating 520 aids in preventing the binder from volitating rapidly thereby forming pockets of gas. The pockets of gas may potentially crack the coating. If desirable convection and radiant heating may be utilize in addition to the microwave heating. In some embodiments microwave heating of the coating 520 may be utilize without prior pressure rolling.

In some variations the insert with the coating thereon may be exposed to microwave energy at a power ranging from 200 MHz to 300 GHz. In some variations the insert with the coating thereon may be exposed to microwave energy at a power ranging from 300 W to 1200 W for a period of 5 seconds to 120 seconds, or so that the temperature of the coating reaches 50 degree C. to 200 degree C. or so that the coating becomes hard or cured. Thereafter, the coating may be cooled by the insert with the coating thereon to room temperature (approximately 25 degrees C.) or to the atmosphere for a period, for example, of 15 seconds to 20 seconds. In one embodiment multiple layers of the coating may be applied and hardened.

In another variation the coating may be cured and braked using a combination of microwave energy and radiant heat and/or convection heat. An oven equipped to provide radiant heat and/or convection heat may also be equipped with a microwave energy source so that an insert have the coating thereon may be subjected to microwave energy and at least one of radiant heat or convection heat.

When the term “over,” “overlying,” “overlies,” “under,” “underlying,” or “underlies” is used herein to describe the relative position of a first layer or component with respect to a second layer or component such shall mean the first layer or component is directly on and in direct contact with the second layer or component or that additional layers or components may be interposed between the first layer or component and the second layer or component.

The above description of embodiments of the invention is merely exemplary in nature and, thus, variations thereof are not to be regarded as a departure from the spirit and scope of the invention.

What is claimed is:

1. A method of manufacturing a product with a coulomb damping surface comprising:
coating a metallic member with a material including friction materials; and
curing said coating comprising exposing the material microwave energy.

2. A method as described in claim 1 wherein the material further comprising mixing a binder with said coating.

3. A method as described in claim 1 further comprising exposing said coating to at least one of radiant energy or convection energy.

4. A method as described in claim 1 wherein said coating comprises at least one of spraying, dipping, injecting or covering said product with said material and wherein said material comprises a fluid, powder or paste.

5. A method of manufacturing a product with a coulomb damping surface comprising:
coating a metallic member with a matter including friction materials to provide a coated member;
pressure rolling said coated member to provide a desired thickness of said material on said metallic member.

6. A method as described in claim 5 further comprising curing said material comprising exposing the material to microwave energy.

7. A method as described in claim 5 wherein said rolling said coated member comprising moving rollers along opposite sides of said coated member.

8. A method as described in claim 7 wherein said coated member is rolled along a generally horizontal path.

9. A method as described in claim 7 wherein said coated member is roiled along a generally vertical path.

10. A method as described in claim 5 further comprising mixing a binder with said friction materials.

11. A method as described in claim 5 wherein a roller utilized for pressure rolling said coated member comprises providing adjustment in position, rotational speed, or force placed thereon to compensate for at least one of a group properties of said metallic member, an environment of said metallic member, or coating, including a force of weight of said metallic member, a viscosity of said coating, a temperature of said coating or said metallic member, a humidity of an atmosphere surrounding said metallic member, a desired thickness of said coating, a differential in a desired thickness of coating versus a thickness of coating sensed of a currently rolled metallic member or a prior rolled metallic member, a sequence of coating of a multiple coated metallic member, a function dependent upon a relationship of a linear displacement or derivatives thereof of the metallic member versus linear displacement or derivatives thereof of a surface of a roller utilized to pressure roll said metallic member.

12. A method as described in claim 11 wherein said adjustment is automatic.

13. A method as described in claim 5 wherein the coating comprises at least one of spraying, dipping, injecting or covering said product with a fluid, powder or paste of said coating.

14. A manufactured product with a coulomb damping surface comprising:
a metallic member comprising a coating thereon comprising friction materials; and
wherein said coating has a substantially uniform thickness free of cracks and bubbles.

15. A product as described in claim 13 wherein said coating includes a binder.

16. A product as described in claim 15 wherein said coating the binder comprises at least one of epoxy resins, phosphoric acid binding agents, calcium aluminates, sodium silicates, wood flour, clays or mixtures thereof.

17. A product as described in claim 14 wherein said friction materials comprises at least one of silica, alumina, graphite with clay, silicon carbide, silicon nitride, cordierite (magnesium-iron-aluminum silicate), mullite (aluminum silicate), zirconia (zirconium oxide), phyllosilicates, non-refractory polymeric materials, ceramics, composites, wood or mixtures thereof.
